(19) United States
(12) Patent Application Publication
(10) Pub. No.: US 2026/0233350 A1
(43) Pub. Date: Aug. 13, 2026

(54) Multiaxial machine tool with a movable column

(71) Applicant: HPT Sinergy S.r.l., Padova (PD) (IT)

(72) Inventor: Gabriele Piccolo, Camposanpiero (PD) (IT)

(21) Appl. No.: 19/161,246

(22) PCT Filed: Mar. 20, 2024
(86) PCT No.: PCT/IB2024/052683

§ 371 Date: Aug. 30, 2025

(30) Foreign Application Priority Data
Mar. 22, 2023 (IT) 102023000005403

(51) Int. Cl. B23Q 1/62; B23Q 1/01; B23Q 5/10

(52) U.S. Cl. CPC B23Q 1/625; B23Q 1/015; B23Q 5/10

(57) ABSTRACT

A multiaxial machine tool with a movable column includes a base anchored to the ground, which is provided with first longitudinal guide and is detached from a worktable. An upright structure slides along the first guide and has a pair of substantially vertical columns connected atop by an upper crosspiece and at the bottom by a lower crosspiece. A carriage slides along the inner walls, mutually facing the columns and defining a transverse axis, and a slide slides on the carriage parallel to the transverse axis and is adapted to cantilever support, at a first transverse end thereof, a tool holder head. The slide has a rotation system for rotating the tool holder head around the transverse axis and the lower crosspiece is arranged at a height at least partly lower than the upper surface of the base.

### FIELD OF THE INVENTION

The present invention generally relates to the technical field of industrial processing machines and it particularly relates to a multiaxial machine tool with a movable column.

### BACKGROUND ART

The use of a substantially longitudinal base anchored to the ground and a substantially vertical upright slidable along the base has been long known in the field of machine tools.

Generally, there is provided a carriage slidable vertically along the upright and a slide adapted to support a tool holder head and movable on the carriage in a direction perpendicular to the axis of the base.

In this type of machines, the tool holder head is arranged facing the worktable to which the workpiece is fixed.

A recurrent problem in these machine tools lies in the fact that the base and the lower base of the upright entail an excessive height of the axis of the tool holder head from the worktable with a resulting reduction of the accessibility to the tool and of the visibility of the workpiece being processed.

In order to overcome this drawback, there have been developed machine tools in which the table is anchored to the bottom of a well previously obtained in the floor of the space where the machine is to be installed and anchor the worktable to the bottom of the well.

In this manner, the axis of the spindle has a lower vertical position which is closer to the work surface and in some cases even beneath it.

However, a major drawback of such known solution lies in the fact that it entails a high well creation cost and the need to use fixed or movable barriers adapted to protect the staff designated and not designated to carry out the works.

In order to overcome this drawback, there have been developed machine tools provided with an upright structure slidable along a base whose structure comprises a pair of columns joined at the upper part and at the lower part by crosspieces and wherein the slide is slidable along the pair of columns, as described in WO2005097402 or CN112846819. In such known solutions, the lower crosspiece is positioned beneath the upper surface of the base to increase the reach of work of the tool holder head.

However, in these known solutions, the entire tool holder head fully is installed at the end of the slide and the centre of gravity of the slide is positioned close to the tool holder head, with resulting increase of the cantilever of the slide and therefore increase the deformations due to the bending of the structure due to the force of gravity.

In order to overcome this drawback, there have been developed machine tools comprising system for compensating the deformations due to the force of gravity, for example by means of active inertia damping systems arranged in the slide and close to the work area, as described in EP3241647.

However, a major drawback of such known solution lies in the fact that it entails a high cost for modifying the structure of the slide, as well as the moving away the point of application of the work forces from the upright of the machine, therefore increasing the distance of the tool holder head from the upright.

In conclusion, in the technical field of industrial processing machines there is particularly felt the need to enable the installation of a multiaxial machine with movable column which has the axis of the spindle the closest possible to the work surface of the machine and/or to the upright so as to reduce the deformations of the slide due to the forces of gravity and increase accessibility to the tool holder head at the same time.

### TECHNICAL PROBLEM

In the light of the prior art, the technical problem addressed by the present invention is to improve a machine tool with movable column to increase the reach of work of the tool holder head and simultaneously decrease the costs relating to the installation, maintenance, and compensation of bending of the slide.

### SUMMARY OF THE INVENTION

The object of the present invention is to solve the aforementioned problem by providing a multiaxial machine tool with a movable column which is highly effective and cost-effective.

A particular object of the present invention is to provide a multiaxial machine tool of the type indicated above that does not require excavation works and which at the same time has the axis of the spindle much closer to the work surface of the machine.

Another particular object of the present invention is to provide a multiaxial machine tool of the type indicated above which significantly reduces the need of systems for compensating the bending of the slide.

A further object of the present invention is to provide a multiaxial machine tool of the type indicated above which allows to approach to the upright structure of the centre of gravity of the assembly formed by the tool holder head and by the slide, as well as the point of application of the work forces.

Another object of the present invention is to provide a multiaxial machine tool of the type indicated above which allows to reduce the deformations of the slide due to the force of gravity.

A further object of the present invention is to provide a multiaxial machine tool del of the type indicated above which reduces the need to use electronic deformation compensation systems.

Another object of the present invention is to provide a multiaxial machine tool of the type indicated above which allows to increase the processing precision.

The objects mentioned above and others which will be more apparent hereinafter, are achieved by a multiaxial machine tool with a movable column, according to claim 1, comprising a base anchored to the ground, provided with first longitudinal guide means and detached from a worktable and an upright structure, slidable along first guide means and having a pair of substantially vertical columns connected atop by at least one upper crosspiece and at the bottom by at least one lower crosspiece.

Furthermore, the machine comprises a carriage slidable along the mutually faced inner walls of the columns and defining a transversal axis and a slide slidable on the carriage parallel to the transversal axis and adapted to cantilever support at a first transversal end thereof a tool holder head.

According to a particular aspect of the invention, the slide comprises therein rotation means for rotating the head around the transversal axis defined by the slide and wherein the lower crosspiece is arranged at a height at least partly lower than the upper surface of the base.

Thanks to this combination of characteristics, the machine tool according to the invention allows to approach, to the upright structure, the centre of gravity of the assembly formed by the tool holder head and by the slide, as well as the point of application of the work forces.

Furthermore, the deformations of the slide decrease significantly so as to avoid the use of the known electronic deformation compensation systems with resulting increase in the processing precision.

Furthermore, the rotation means of the head along the transversal axis of the slide are arranged inside the head with ensuing possibility of using a smaller number of dedicated variants of processing heads, given that the integrated motor is shared by several heads.

Advantageous embodiments of the invention are attained according to the dependent claims.

### BRIEF DESCRIPTION OF THE DRAWINGS

Further characteristics and advantages of the invention will be more apparent in the light of the detailed description of a preferred but not exclusive embodiment of a multiaxial machine tool with a movable column like the one mentioned above, shown by way of non-limiting example with reference to the drawings below, wherein:

FIGS. 1A and 1B are perspective views of a machine tool known in the prior art, respectively with the slide lowered and with the slide raised;

FIGS. 2A and 2B are front views respectively of the machine of FIGS. 1A and 1B;

FIGS. 3A and 3B are lateral views respectively of the machine of FIGS. 2A and 2B;

FIGS. 4A and 4B are perspective views of the multiaxial machine tool with a movable column according to the invention, respectively with the slide lowered and with the slide raised;

FIGS. 5A and 5B are front views respectively of the machine of FIGS. 4A and 4B according to the invention;

FIGS. 6A and 6B are lateral views respectively of the machine of FIGS. 5A and 5B according to the invention.

### DETAILED DESCRIPTION OF A PREFERRED EMBODIMENT

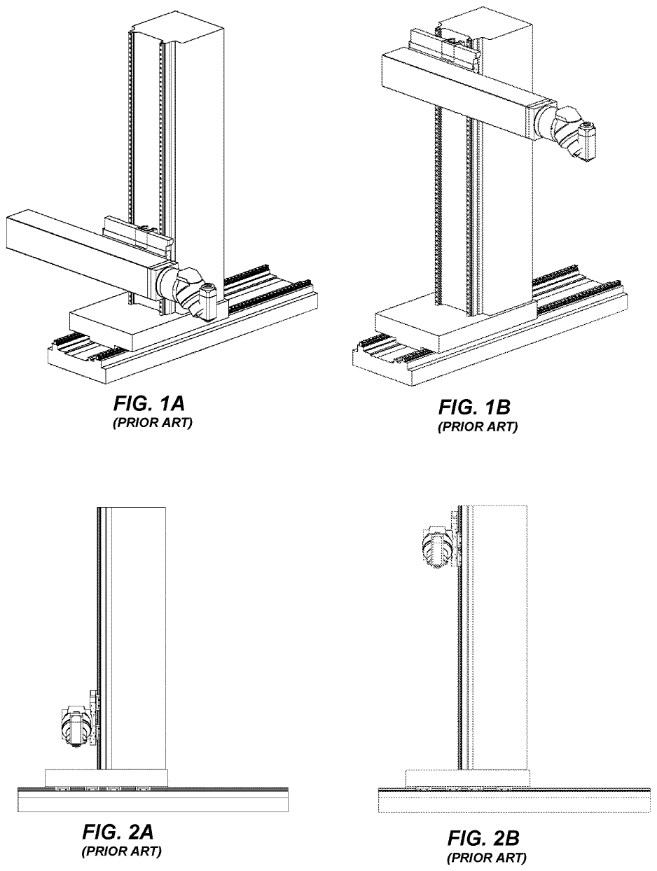

FIGS. 1A, 1B, 2A, 2B, 3A and 3B show a multiaxial machine tool with a movable upright of the prior art, which comprises a substantially longitudinal base anchored to the ground and a substantially vertical upright slidable along the base.

A machine of this type further comprises a carriage slidable vertically along the upright and a slide adapted to support a tool holder head and movable on the carriage in a direction perpendicular to the axis of the base.

In this type of machines, the tool holder head is arranged facing a worktable to which the workpiece is fixed.

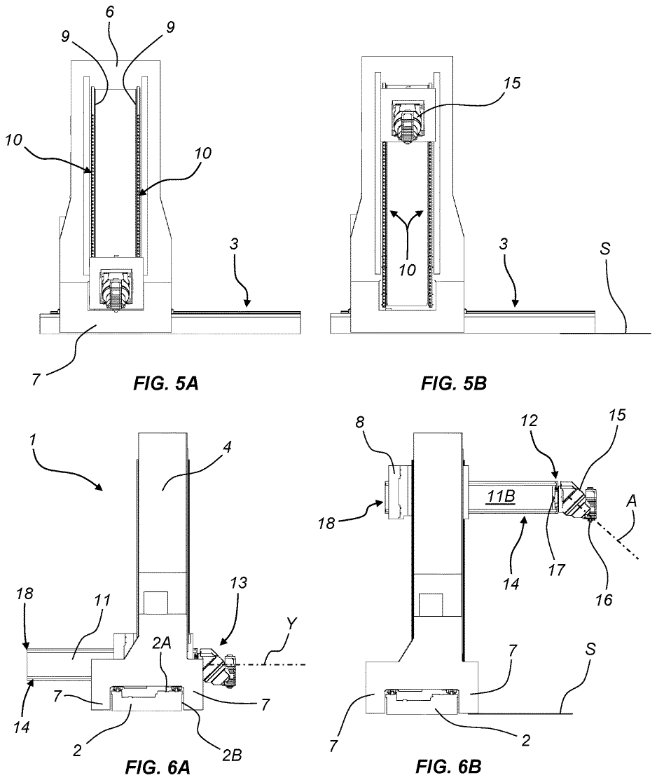

With particular reference to FIGS. 4-6, there is shown a multiaxial machine tool with a movable column according to the present invention, indicated in its entirety with reference numeral 1, for industrial processing operations, for example for removing material on semi-finished products or mechanical workpieces, generally made of metal.

In its most essential embodiment, the machine 1 comprises a base 2 anchored to the ground S, provided with first longitudinal guide means 3 and detached from a worktable, the latter not shown in the figures.

The worktable may be provided with per se known anchoring means for bracketing the workpieces to be processed, not shown in the drawings.

Furthermore, there is provided an upright structure 4, slidable along the first guide means 3 and of the symmetrical portal type, that is, having a pair of substantially vertical columns 5 connected atop by at least one upper crosspiece 6 and at the bottom by at least one lower crosspiece 7.

In a preferred embodiment of the invention, the columns of the pair 5 are connected at the bottom by a pair of lower crosspieces 7 each laterally embracing the base 2.

It should be observed that the first guide means 3 are substantially horizontal and they are interposed between the base 2 and the upright structure 4.

Preferably, the first guide means 3 are positioned between the upper surface 2A of the base 2 and the lower surface 4A of the upright structure 4, as shown in the figures.

Alternatively, the first guide means 3 are positioned on the lateral surface 2B of the base 2.

The machine 1 also comprises a carriage 8 slidable along the inner walls 9 mutually facing the columns of the pair 5 and defining a transversal axis Y.

As better shown in FIGS. 4-6, there are provided second substantially vertical guide means 10 interposed between the faced inner walls 9 of the columns 5 and the carriage 8 for the sliding of the latter along the upright structure 4.

Furthermore, there is provided a slide 11 slidable on the carriage 8 parallel to the transversal axis Y and adapted to cantilever support at a first transverse end 12 thereof a tool holder head 13.

As better observable in the figures, there are provided third guide means 14 which are substantially transversal and perpendicular with respect to said first guide means 3 and interposed between the carriage 8 and the slide 11 to slidably guide the latter with respect to the carriage 8.

Preferably, the third guide means 14 are positioned on the lateral surfaces 11B of the slide 11.

In a per se known manner, there are provided respective means for moving said upright structure 4 along the first guide means 3, the carriage 8 along the second guide means 10 and the slide 11 along the third guide means 14.

Furthermore, the movement means may be of the conventional type and therefore consist of a male-female screw coupling, or a linear electric motor, or a rack/pinion combination or other similar combination of drive members.

The machine tool 1 described above is provided with conventional command and control systems which allow the tool holder head 13 mounted on the first end 12 of the slide 11 to perform the processing operations according to the desired processing procedure that the machine is to carry out on the semi-finished product positioned on the work bench.

Furthermore, said tool holder head 13 comprises an external end 15 provided with a tool holder shank 16 and rotatably mounted around a respective rotation axis A which is inclined with respect to said transversal axis Y.

According to a particular aspect of the invention, the at least one lower crosspiece 7 is arranged at a height at least partly lower than the upper surface 2A of the base 2.

Furthermore, the slide 11 comprises therein rotation means 17 for rotating the tool holder head 13 around the transversal axis Y.

Thanks to this combination of characteristics, the machine tool 1 according to the invention and shown in FIGS. 4-6 is particularly advantageous with respect to the conventional machines, shown by way of example in FIGS. 1-3, given that it allows the tool holder head 13 to reach a position that is very close to the worktable without the base 2 having to be installed in a well, and therefore without requiring strenuous and expensive excavation works.

This advantage is evident upon comparing FIGS. 1A, 2A and 3A relative to a machine tool according to the prior art respectively with FIGS. 4A, 5A and 6A relative to a multiaxial machine tool according to the invention.

This comparison shows that the slide 11, in an operative position close to the worktable, is closer to the worktable with respect to the conventional configurations.

At the same time, the positioning of the rotation means 17 inside the slide 11, allows to approach the head 13 to the upright structure 4 and the centre of gravity of the slide 11 to the base 2, with resulting decrease in the bending forces acting on the slide 11.

In other words, the decrease in the bending forces acting on the slide 11 allows to reduce the need to use compensation systems with resulting obtainment of more precise and repeatable processing operations.

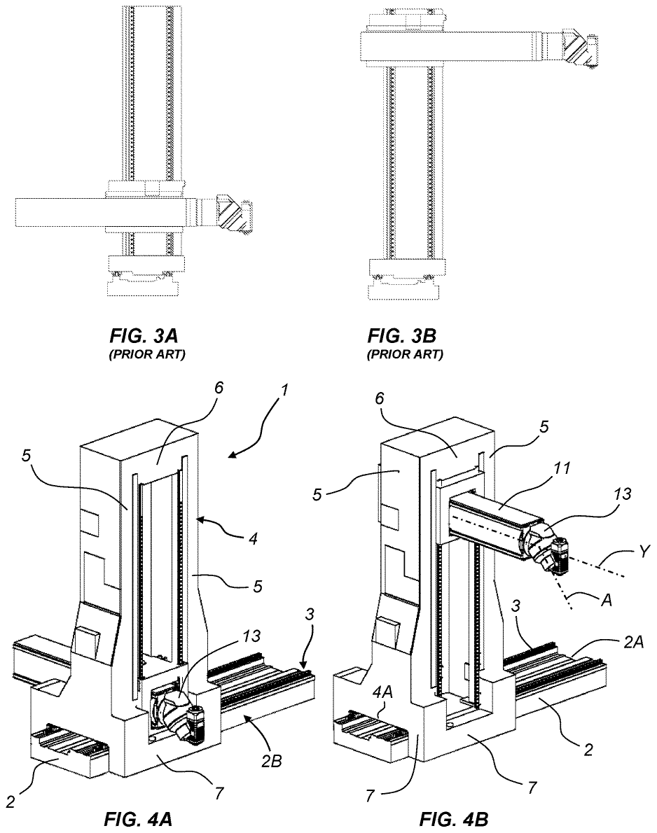

This further advantage is evident upon comparing FIGS. 1B and 3B relative to a machine tool according to the prior art respectively with FIGS. 4B and 6B relative to a multiaxial machine tool according to the invention.

This comparison shows that the tool holder head 13 is closer to the upright structure 4.

Suitably, the rotation means 17 for rotating the tool holder head 13 around the transversal axis Y are directly and removably attachable to the tool holder head 13 without any intermediate gearbox and they comprise a pin, driven by a direct drive motor. Therefore, this drive motor is of the high torque and low velocity type.

The slide 11 comprises a system for the quick coupling of the tool holder head 13 which protrudes from the first transversal end 12 of the slide 11.

In other words, given that the ration means 17 for rotating the tool holder head 13 are integrated in the slide 11, the dedicated variants of the processing heads 13 can be used at a lower cost, given that the rotation means are shared by multiple heads 13.

In a per se known manner, the slide 11 comprises a main motor, not shown in the figures, adapted to drive a rotary shaft of the tool mounted on the shank 16 and contained inside the slide 11.

The main motor is positioned close to a second transversal end 18 of the slide 11, opposite to the first transversal end 12.

It should be observed that the drive motor of the rotation means 17 is arranged concentrically to the rotary shaft of the tool of the tool holder head 13 and it is independent from the latter.

From the combination of these advantages, the machine tool according to the invention is highly versatile, which yields lesser processing times at a lower cost, allowing to use only one machine for the entire cycle for providing the semi-finished product.

In the light of the description above, it is clear that the multiaxial machine tool with a movable column according to the invention achieves the pre-established objects and in particular it allows to increase the reach of work of the tool holder head and at the same time decrease the costs relating to the installation, maintenance and compensation of the bending of the slide.

The machine according to the invention is susceptible to numerous modifications and variants all falling within the inventive concept outlined in the attached claims.

Even though the machine has been described with reference to the attached figures, the reference numbers utilised in the description and in the claims are meant for improving the intelligibility of the invention and thus do not limit the claimed scope of protection in any manner whatsoever.

Throughout the description, reference to “an embodiment” or “the embodiment” or “some embodiments” indicate that a particular characteristic, structure or element described is comprised in at least one embodiment of the object of the present invention.

Furthermore, the particular characteristics, structures or elements may be combined in any appropriate fashion in one or more embodiments.

### INDUSTRIAL APPLICABILITY

The present invention can be applicable at industrial level because it can be produced in an industrial scale by industries belonging to the field of machine tools for industrial processing operations.

The invention claimed is:

1. A multiaxial machine tool (1) with a movable column, comprising:
i. a base (2) anchored to a ground (S), provided with first longitudinal guide means (3) and detached from a worktable;
ii. an upright structure (4), sliding along said first longitudinal guide means (3) and having a pair of substantially vertical columns (5) connected atop by at least one upper crosspiece (6) and at a bottom by at least one lower crosspiece (7);
iii. a carriage (8) slidable along the inner walls (9) mutually facing said substantially vertical columns (5), said carriage defining a transverse axis (Y); and
iv. a slide (11) slidable on said carriage (8) and parallel to said transverse axis (Y). said slide being adapted to cantilever support, at a first transverse end (12) thereof, a tool holder head (13);
wherein said at least one lower crosspiece (7) is arranged at a height at least partly lower than and upper surface (2A) of said base (2); and
wherein said slide (11) comprises therein rotation means (17) for rotating said tool holder head (13) around said transverse axis (Y) to allow to approach said head (13) to said upright structure (4) and a center of gravity of said slide (11) to said base (2) to decrease the bending forces acting on said slide (11).

2. The multiaxial machine tool as claimed in claim 1, wherein said rotation means (17) are directly and removably attachable to said tool holder head (13) without any intermediate gearbox.

3. The multiaxial machine tool as claimed in claim 1, wherein said rotation means (17) comprise a pin driven by a drive motor.

4. The multiaxial machine tool as claimed in claim 1, wherein said slide (11) comprises a system for a quick coupling of said tool holder head (13), said system protruding from said first transverse end (12).

5. The multiaxial machine tool as claimed in claim 1, further comprising a main motor for driving a rotation shaft of a tool of said tool holder head (13), which is contained inside said slide (11).

6. The multiaxial machine tool as claimed in claim 5, wherein said main motor is positioned adjacently to a second transverse end (18) of said slide (11) opposite to said first transverse end (12).

7. The multiaxial machine tool as claimed in claim 1, further comprising substantially vertical second guide means (10) interposed between the inner walls (9) of said columns (5) and said carriage (8) for sliding of the carriage.

8. The multiaxial machine tool as claimed in claim 7, further comprising substantially transverse third guide means (14) interposed between said carriage (8) and said slide (11) for slidably guiding the slide with respect to said carriage (8).

9. The multiaxial machine tool as claimed in claim 8, wherein said third guide means (14) are positioned on lateral surfaces (11B) of said slide (11).

10. The multiaxial machine tool as claimed in claim 9, further comprising respective means for moving said upright structure (4) along said first longitudinal guide means (3), said carriage (8) along said second vertical guide means (10) and said slide (11) along said third transverse guide means (14).

11. The multiaxial machine tool as claimed in claim 1, wherein said tool holder head (13) comprises an outer end (15) provided with a tool holder shank (16) rotatably mounted around a respective rotation axis (A), which is inclined with respect to said transverse axis (Y).

12. The multiaxial machine tool as claimed in claim 1, wherein the at least one lower crosspiece connecting the substantially vertical columns comprises a pair of lower crosspieces (7) each laterally embracing said base (2).
